(19) United States
(12) Patent Application Publication
(10) Pub. No.: US 2026/0369126 A1
(43) Pub. Date: Nov. 19, 2026

(54) SYSTEMS AND METHODS FOR GENERATING AND PROVIDING SHARED FEATURES IN ELECTRONIC WAGERING GAMES

(71) Applicant: Aristocrat Technologies, Inc., Las Vegas, NV (US)

(72) Inventors: Nicholas Farina, Granger, IN (US); Rogelio Decasa, JR., Renton, WA (US)

(21) Appl. No.: 19/536,310

(22) Filed: Feb. 11, 2026

Related U.S. Application Data
(60) Provisional application No. 63/768,732, filed on Mar. 7, 2025.

(51) Int. Cl. G07F 17/32

(52) U.S. Cl. CPC G07F 17/3267; G07F 17/3272

(57) ABSTRACT

An electronic gaming system is provided that includes a display device and a controller that conducts a base game among a group of players by mapping game symbols to symbol positions in a game window, displaying the game symbols, and triggering a group bonus game upon reaching a threshold number of a specified symbol among the group of players. The controller also conducts the group bonus game among the group of players by: displaying a group bonus game window with symbols of the base game and boost features, displaying a moving pointer that lands in different positions and incorporates those symbol positions in the group bonus game window, incrementing the values of those symbol positions that are incorporated by the moving pointer and, upon ending, making an award of those values indicated by the incremented values in each symbol position. Various other systems and methods are also disclosed.

### CROSS REFERENCE TO RELATED APPLICATION(S)

This application claims priority to U.S. Provisional Patent Application No. 63/768,732, filed 7 Mar. 2025, the entire contents of which are incorporated herein by reference.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Casinos and other gaming establishments typically have multiple different types of electronic wagering games. Some of these games include Class III games, which include traditional slot type games or matching games. Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome, and symbols are then selected which correspond to that outcome. Notably, some games may include an element of skill on the part of the player and are therefore not entirely random.

### SUMMARY

As will be described in greater detail below, the instant disclosure generally relates to systems and methods for generating and providing shared bonus features or shared bonus games in electronic wagering games. In some embodiments, an electronic gaming system may be provided that includes a display device operable to display at least a portion of multiple reels, where each reel has multiple symbol positions. The electronic gaming system also includes a controller having a processor and memory storing a symbol set including multiple symbols, and instructions, which, when executed, cause the processor to: conduct a base game among a group of players by mapping, based on random numbers generated by a random number generator, multiple game symbols from a set of reel strips to different symbol positions in a first game window, controlling the display device to display the game symbols, selected from the set of reel strips using the random number generator, in the symbol positions in the first game window, and triggering a group bonus game upon reaching a threshold number of at least one specified symbol among the group of players of the base game.

The controller also conducts the group bonus game among the group of players by controlling the display device to display a group bonus game window that includes the specified symbols of the base game and multiple boost features in symbol positions of the group bonus game window, causing the display device to display a moving pointer that lands in different positions in the group bonus game window, where the moving pointer incorporates a different plurality of symbol positions and corresponding values in each landing position, incrementing the values of those symbol positions that are incorporated by the moving pointer in its current position and, upon determining that an end condition has been reached, and accessing the memory to make an award of values indicated by the incremented values in each symbol position that is incorporated by the moving pointer in its current position.

In some examples, each player in the group of players plays the base game at a separate electronic gaming system. In some cases, the group bonus game is shared across the various separate electronic gaming systems. In some examples, the group bonus game further includes a spinning wheel with at least two symbol values. In some embodiments, upon reaching a specified number of a first symbol value, the end condition is triggered. In some cases, upon landing on a second symbol value in the spinning wheel, the values of those symbol positions currently included in the moving pointer are increased.

In some examples, the group bonus game includes at least two pointers that each incorporates a different plurality of symbol positions and corresponding values in each landing position. In some cases, the values of each of the symbol positions that are incorporated by the at least two moving pointers are incremented. In some examples, the group of players includes a variable number of players between a lower limit and an upper limit. In some embodiments, the base game presents a player icon corresponding to one of the players in the group of players for each symbol position that has landed a cash on reels (COR) symbol.

In some cases, game symbols are presented differently for one user's CORs than a different user's CORs. In some embodiments, the base game is played on a 3×5 grid, and wherein a 4×5 grid displays the CORs accumulated by the group of players. In some examples, at least some of the COR values in the 4×5 grid displaying the accumulated CORs are transferred to the group bonus game. In some cases, the group bonus game is played on a 5×5 grid that includes the COR values accumulated by the group of players and includes five boost values. In some embodiments, the COR values are shuffled prior to being placed in the 5×5 grid of the group bonus game. In some examples, the five boost values are variable for each group bonus game. In some cases, conducting the base game further includes presenting a message indicating that players that did not get into the group bonus game will be eligible to play for a subsequent group bonus game. In some cases, players that did not get into the group bonus game include players that did not land on a COR in the base game.

In addition to the electronic gaming system described above, a corresponding computer-implemented method may be provided. The method includes conducting a base game among a group of players by mapping, based on random numbers generated by a random number generator, multiple game symbols from a set of reel strips to different symbol positions in a first game window, controlling the display device to display the game symbols, selected from the set of reel strips using the random number generator, in the symbol positions in the first game window, and triggering a group bonus game upon reaching a threshold number of at least one specified symbol among the group of players of the base game. The method further includes conducting the group bonus game among the group of players by controlling the display device to display a group bonus game window that includes the specified symbols of the base game and multiple boost features in symbol positions of the group bonus game window, causing the display device to display a moving pointer that lands in different positions in the group bonus game window, where the moving pointer incorporates a different plurality of symbol positions and corresponding values in each landing position, incrementing the values of those symbol positions that are incorporated by the moving pointer in its current position and, upon determining that an end condition has been reached, accessing the memory to make an award of values indicated by the incremented values in each symbol position that is incorporated by the moving pointer in its current position.

In addition to the electronic gaming system described above, a non-transitory computer-readable medium may be provided that includes computer-executable instructions that, when executed by a hardware processor of a computing device, cause the hardware processor to: conduct a base game among a group of players by mapping, based on random numbers generated by a random number generator, multiple game symbols from a set of reel strips to different symbol positions in a first game window, controlling the display device to display the game symbols, selected from the set of reel strips using the random number generator, in the symbol positions in the first game window, and triggering a group bonus game upon reaching a threshold number of at least one specified symbol among the group of players of the base game. The hardware processor further conducts the group bonus game among the group of players by controlling the display device to display a group bonus game window that includes the specified symbols of the base game and multiple boost features in symbol positions of the group bonus game window, causing the display device to display a moving pointer that lands in different positions in the group bonus game window, where the moving pointer incorporates a different plurality of symbol positions and corresponding values in each landing position, incrementing the values of those symbol positions that are incorporated by the moving pointer in its current position and, upon determining that an end condition has been reached, accessing the memory to make an award of values indicated by the incremented values in each symbol position that is incorporated by the moving pointer in its current position.

Features from any of the above-mentioned embodiments may be used in combination with one another in accordance with the general principles described herein. These and other embodiments, features, and advantages will be more fully understood upon reading the following detailed description. While the exemplary embodiments described herein are susceptible to various modifications and alternative forms, specific embodiments will be described in detail herein. However, the exemplary embodiments described herein are not intended to be limited to the particular forms disclosed. Rather, the instant disclosure covers all modifications, equivalents, and alternatives falling within this disclosure.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 is an exemplary diagram showing several electronic gaming machines (EGMs) networked with various gaming related servers.

FIG. 2A is a block diagram showing various functional elements of an exemplary EGM.

FIG. 2B is an exemplary diagram that depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a block diagram of an exemplary system for generating and providing shared bonus features in electronic wagering games according to one or more implementations of this disclosure.

FIG. 5 is a block diagram of an exemplary graphical interface of an electronic wagering game according to one or more implementations of this disclosure.

FIG. 6 is a flow diagram of an exemplary computer-implemented method for generating and providing shared bonus features in electronic wagering games according to one or more implementations of this disclosure.

FIG. 7 illustrates an embodiment in which COR values are applied to bonus entry in an electronic wagering game according to one or more implementations of this disclosure.

FIGS. 8A-8E illustrate embodiments in which a bonus game implements moving pointers to increment bonus values within an electronic wagering game according to one or more implementations of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION

Embodiments of the instant disclosure are generally directed to generating and providing shared bonus features and shared bonus games within electronic wagering games. In some examples, the electronic gaming systems may include or represent an EGM having a display, one or more input devices, a value input device, or a game controller coupled to the display, the input devices, or the value input device. The game controller may be configured to control the display to present or display an electronic wagering game. The game controller may present or display these various wager options in the electronic wagering game.

For each spin within the electronic wagering game, each symbol landing may be populated with a symbol, where different symbols or combinations of symbols selected for symbol landings may yield different gameplay outcomes. The disclosed shared bonus features may include a variety of features. In one example, a group of players may each play a base game. As they each play the base game, they will land on cash on reels (COR) values. These COR values may then populate a bonus grid. Once the bonus grid is populated with COR values from the various players in the group, those players that have contributed COR values to the bonus grid may compete in a shared bonus game. The shared group bonus game may include moving pointers that increase the values of those grid positions that are included in the moving pointer. The group bonus game may allow players to keep increasing bonus values through spins of a wheel. Once an end condition has been reached, the enhanced grid values are paid out to the winner(s) of the group bonus game.

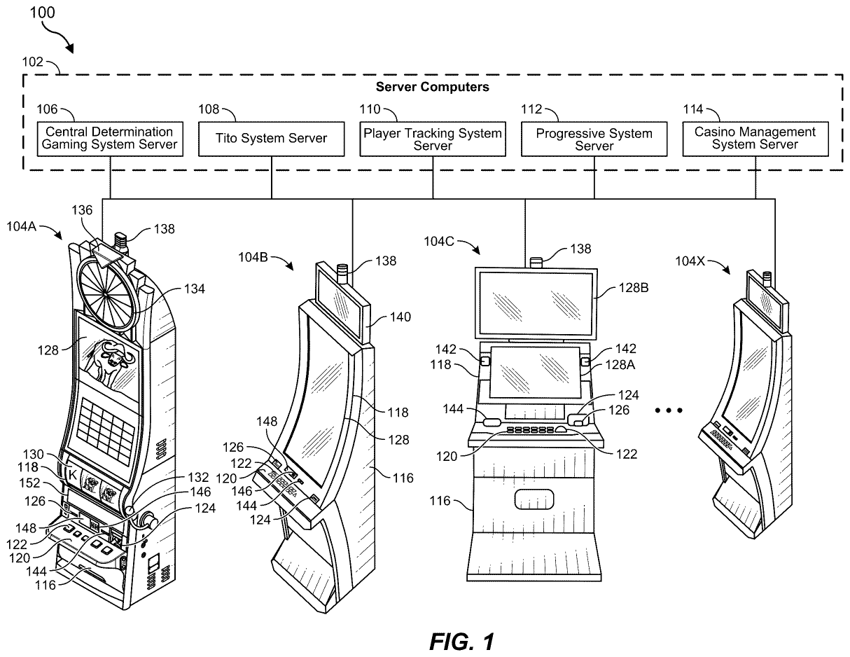

The disclosed shared bonus features and shared bonus games, which increase wins and/or the size of wins during gameplay, optimize computational efficiency by providing greater gameplay variation without the need for constant manual adjustments. For instance, in some examples, the disclosed shared bonus games may be activated using a math control table in which a bonus game is activated whenever a certain combination of selections occurs (e.g., at random), from the math control table. Moreover, in some cases where random numbers are generated and implemented within the electronic wagering game, the systems herein may carefully control or change the amount of randomness for each spin and/or for each reel in the spin to craft a specific outcome or range of outcomes. These concepts will be described below in greater detail with reference to FIGS. 1-8E.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

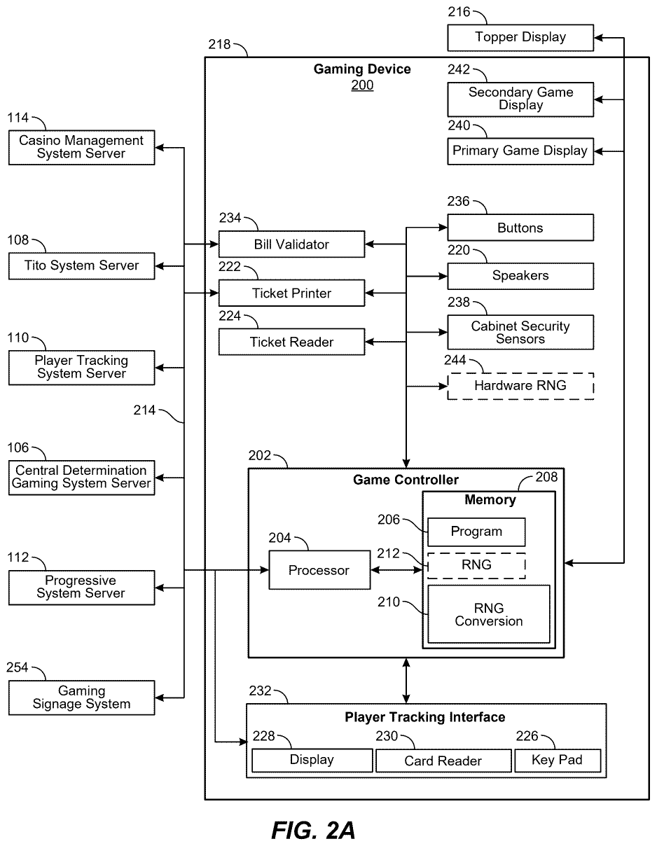

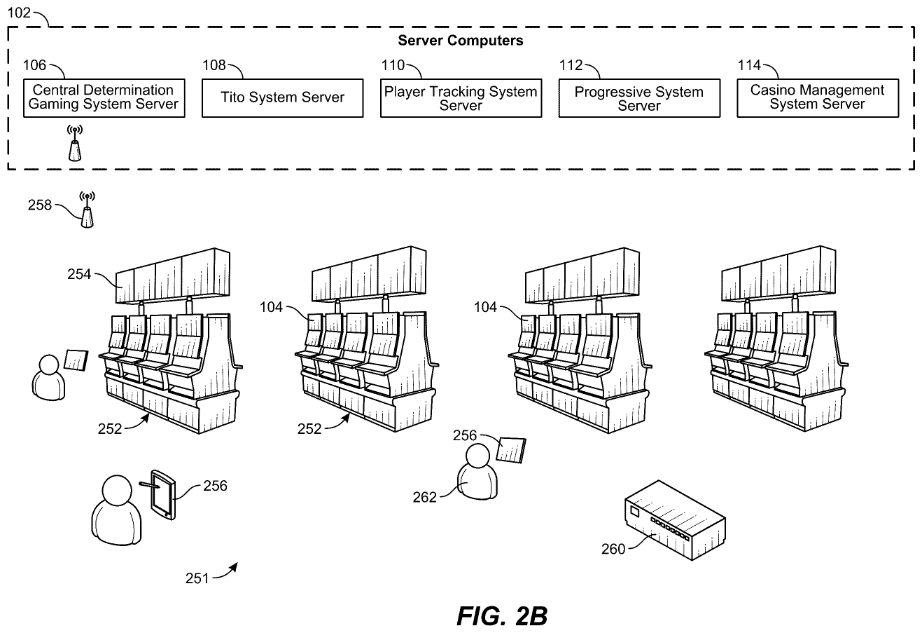

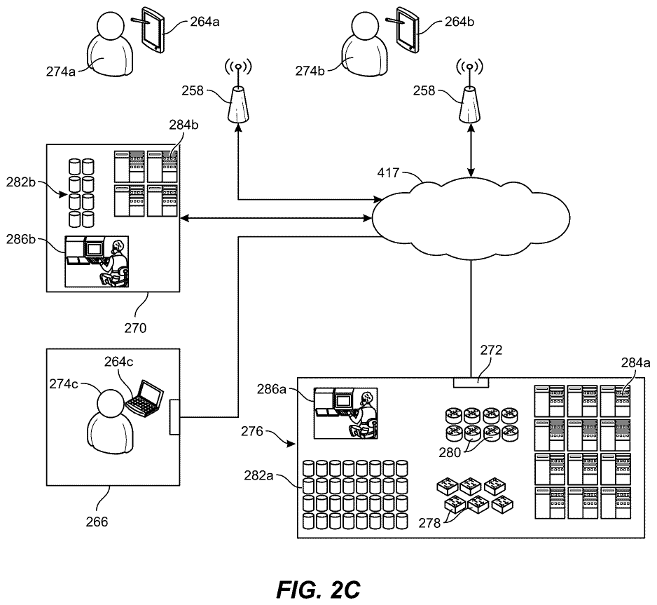

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

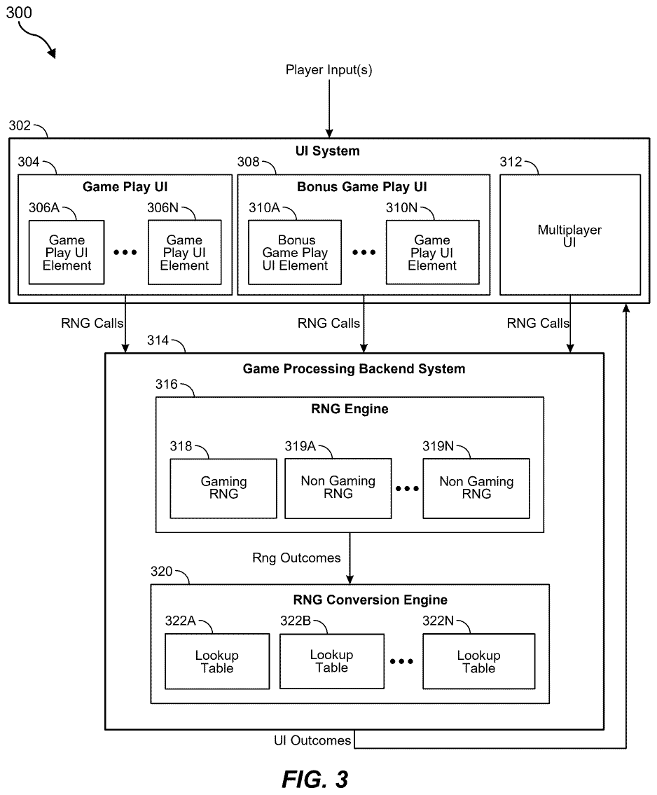

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

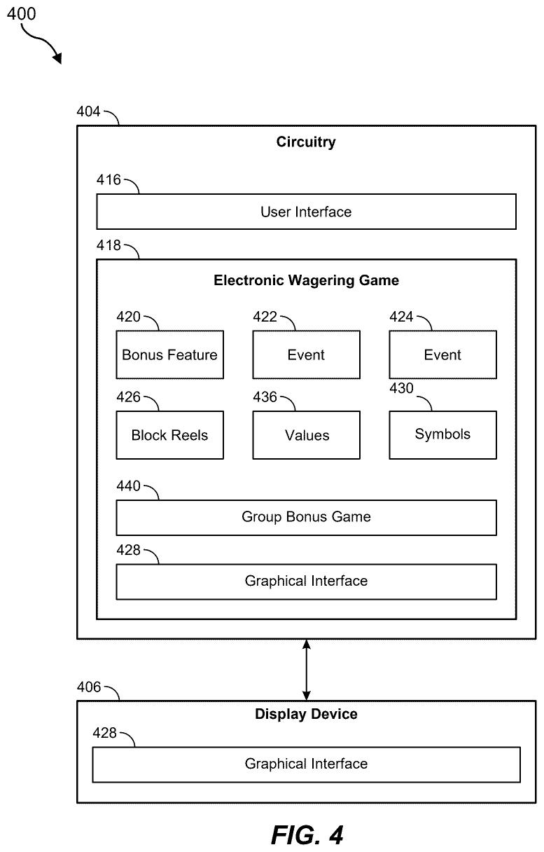

Turning now to FIGS. 4-8E, embodiments for generating and providing shared bonus features and shared bonus games within electronic wagering games will be described in conjunction with the systems and methods described above in FIGS. 1-3. FIG. 4 illustrates an exemplary system 400 for providing and displaying visually interactive bonus features, including a shared bonus game, within electronic wagering games. As illustrated in FIG. 4, system 400 may include or represent circuitry 404 and a display device 406. In some examples, circuitry 404 may implement or execute an electronic wagering game 418 in conjunction with display device 406. In one example, circuitry 404 may include or represent a user interface 416 that enables a user to enter or provide input in connection with electronic wagering game 418. In this example, circuitry 404 may direct or cause display device 406 to render or present a graphical interface 428 of electronic wagering game 418 for viewing by the user.

In some examples, electronic wagering game 418 may include or represent block reels 426 configured to spin in connection with wagers made by the user. In one example, block reels 426 may include, represent, or render symbols 430 that spin, rotate, or change during gameplay. In this example, certain combinations or sequences of symbols 430 across block reels 426 may constitute a win or increase for the user. As a result, the electronic wagering game 418 may award or grant, to the user, a certain monetary value or credit associated with one or more of symbols 430 or their corresponding combinations or sequences.

In some examples, circuitry 404 may detect, recognize, or identify an event 422 that triggers or activates a bonus feature 420, such as a free spins feature. For example, event 422 may include or involve determining that block reels 426 have rendered a threshold number of select symbols (e.g., scatter symbols) during a pre-bonus reel spin. In another example, event 422 may include or represent a random occurrence, a performance-driven occurrence, a wager-driven occurrence, or a time-driven occurrence. For example, event 422 may occur as a result of random number generation. Additionally or alternatively, event 422 may occur as a result of a certain amount of time having elapsed since a previous bonus was awarded by electronic wagering game 418. In other cases, event 422 may occur upon reaching a specified number of COR values in a shared bonus grid that is shared among a group of players.

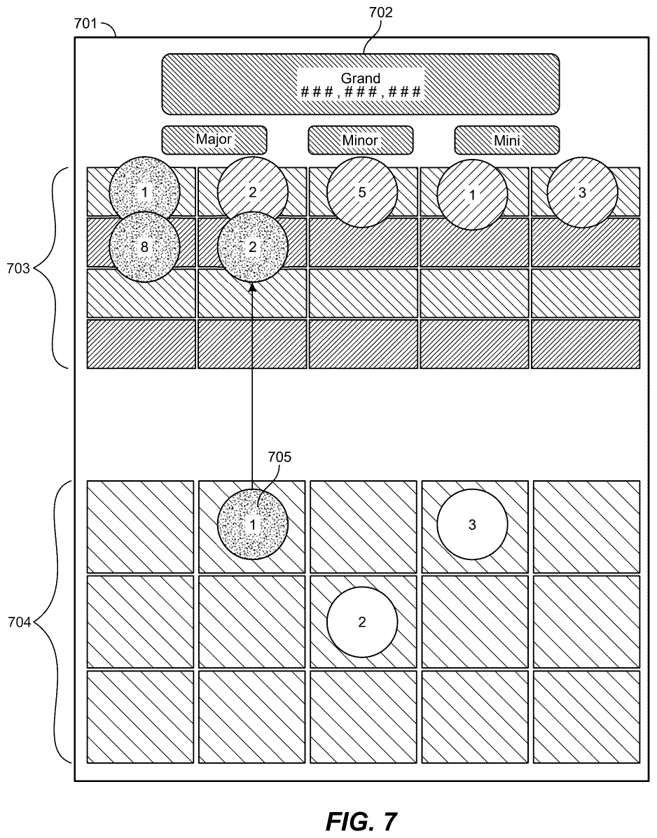

In some examples, circuitry 404 may implement or execute a group bonus game 440 within electronic wagering game 418 in response to event 422. In one example, group bonus game 440 may include a 5×5 grid of positions, with 20 positions having numerical values and five positions having boosts or enhancements. The grid of positions may also include a moving pointer that incorporates some number of grid positions (e.g., five positions). The group bonus game 440 may also include a spinning wheel with multiple instances of two values (e.g., “angel” and “devil”). When a player spins an “angel” value (or some other designated value), those grid positions that are currently included by the moving pointer may increase in value by a set amount, by a random amount, or by an amount tied to the boost enhancements in the grid. When a player spins a “devil” value, either the first time or the third time or some other time, an end condition 424 will be met and the shared group bonus game will end. The circuitry 404 will then return the electronic wagering game to its original form with the base game (e.g., the 3×5 array in graphical interface 701 of FIG. 7).

In some examples, circuitry 404 may include or represent one or more electrical or electronic circuits capable of processing, applying, modifying, transforming, displaying, transmitting, receiving, or executing data for system 400. Circuitry 404 may be communicatively or electrically coupled to display device 406. In one example, circuitry 404 may access or analyze data stored in memory to facilitate or support providing or displaying visually interactive bonus features in electronic wagering games. Additionally or alternatively, circuitry 404 may launch, perform, or execute certain executable files, code snippets, or computer-readable instructions to facilitate or support activating or displaying conditional bonus feature 420. In certain implementations, circuitry 404 may provide display device 406 with instructions or commands that, upon execution, cause display device 406 to present and/or modify graphical interface 428 in accordance with the progression of electronic wagering game 418.

Although illustrated as a single unit in FIG. 4, circuitry 404 may include or represent a collection of multiple processing units or electrical or electronic components that work or operate in conjunction with one another. In one example, circuitry 404 may include or represent a central processing unit (CPU) and/or a graphics processing unit (GPU). In another example, circuitry 404 may include or represent an application-specific integrated circuit (ASIC). In certain implementations, circuitry 404 may be included in or incorporated in an EGM.

Additionally or alternatively, circuitry 404 may be included or incorporated in a server or one or more client devices of system 400. Examples of circuitry 404 include, without limitation, processing devices, microprocessors, microcontrollers, GPUs, CPUs, ASICs, field-programmable gate arrays (FPGAS), systems on chips (SoCs), parallel accelerated processors, tensor cores, integrated circuits, chiplets, optical modules, receivers, transmitters, transceivers, storage devices, memory devices, logical circuitry, portions of one or more of the same, variations or combinations of one or more of the same, or any other suitable circuitry.

In some examples, graphical interface 428 of electronic wagering game 418 may include or represent one or more graphical representations or visuals. In one example, graphical interface 428 may include or represent graphical objects that represent certain features or attributes of the gameplay, such as values 436 or credits accumulated by various users, increments on progressives, durations or amounts of time since the last time a certain bonus was awarded, etc. Additionally or alternatively, graphical interface 428 may include or represent perceived-persistence graphics, pseudo-persistence graphics, and/or true-persistence graphics.

In some examples, the various devices, components, or features described in connection with FIG. 4 may include or represent one or more additional circuits, components, or features that are not necessarily illustrated or labeled in FIG. 4. For example, the systems, components, or features illustrated in FIG. 4 may also include or represent additional analog or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices or structures, processing devices, storage devices, memory devices, circuit boards, sensors, packages, substrates, housings, servers, client devices, computing devices, combinations or variations of one or more of the same, or any other suitable components. In certain implementations, one or more of these additional circuits, components, or features may be inserted or applied between any of the existing circuits, components, or features illustrated in FIG. 4 consistent with the aims or objectives described herein. Accordingly, the couplings or connections described with reference to FIG. 4 may be direct connections with no intermediate components, devices, or nodes or indirect connections with one or more intermediate components, devices, or nodes.

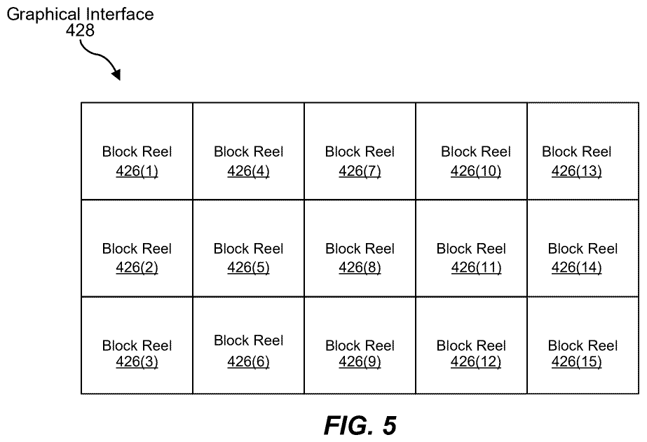

FIG. 5 illustrates an exemplary implementation of graphical interface 428 presented via display device 406. In some examples, graphical interface 428 may include or represent certain elements, components, and/or features that perform or provide functionalities that are similar or identical to those described above in connection with any of FIGS. 1-4. As illustrated in FIG. 5, graphical interface 428 may include or represent a reel window or matrix consisting of block reels 426(1), 426(2), 426(3), 426(4), 426(5), 426(6), 426(7), 426(8), 426(9), 426(10), 426(11), 426(12), 426(13), 426(14), and 426(15). For example, graphical interface 428 may constitute or represent a 3×5 reel window or array prior to the implementation of a conditional bonus feature 420. In certain implementations, each of block reels 426(1)-(15) may constitute or represent an independent reel of the electronic wagering game 418.

In some embodiments, an electronic gaming system may be provided. The electronic gaming system may include a housing. The housing may be similar to or the same as cabinet 218 described above in conjunction with FIG. 2. The housing may provide structural support for an electronic display device that is mounted to the housing. The housing may also provide structural support for at least one input device using which a game player can provide inputs to the electronic gaming system. The input device may be a physical button or set of buttons that are pressed, alone or in conjunction, to provide game inputs. The input device may additionally or alternatively include a touchscreen display that provides input graphical display elements.

The electronic gaming system may also include a value input device and/or a value output device. The value input device may include a physical bill acceptor, a coin acceptor, or an electronic card reader configured to wirelessly or physically interface with a credit card, debit card, or stored value card that adds money or credits with which to wager. The value input device may be linked to monetary systems or databases that provide value to the electronic gaming system that can be used within the electronic wagering game. The value output device may similarly include a bill acceptor or bill output device or coin acceptor or output device that dispenses physical currency.

The value output device may also include an electronic card reader that wirelessly or physically interfaces with a credit card, debit card, stored value card, or digital wallet to apply money to that card or associated account or dispense payout of physical currency. Both the value input device and the value output device may be controlled by a controller of the electronic gaming system to receive value (physical currency or electronic currency) or return value (physical or electronic currency) to the user. The controller may cause the value input device or value output device to perform these functions upon receiving signals from the electronic wagering game indicating that currency debits or returns are to occur based on one or more in-game actions. For instance, the controller may be configured to detect, via the value input device, a physical item associated with a monetary value that establishes a monetary balance (e.g., a cash bill or a credit card). The controller may be further configured to receive, via the input device, a wager that is drawn from the monetary balance. At the conclusion of a game, the value output device, in response to a cashout input received via the input device, may dispense a payout from the monetary balance.

At least in some cases, the electronic gaming system may include a mobile electronic device (e.g., a smartphone, a tablet, a smartwatch, a laptop, or similar computing device). Such a mobile electronic device may include a housing that provides structural support for internal electronic components, including a controller, a value input device or value output device (e.g., a Bluetooth card reader or near-field communication (NFC) chip reader), or a touchscreen input device that a game player can use to provide inputs to the electronic gaming system.

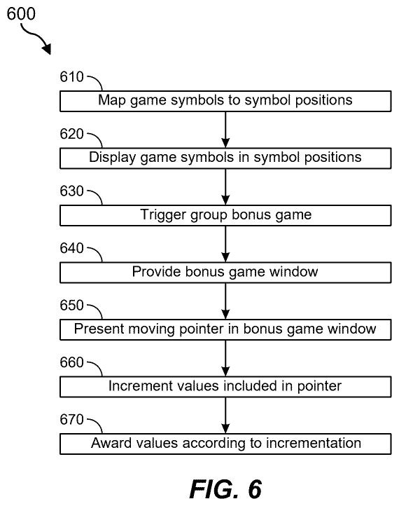

The controller of the electronic gaming system may be further configured to perform a method for generating and providing conditional bonus features in electronic wagering games. This method is generally shown in FIG. 6. FIG. 6 is a flow diagram of an exemplary computer-implemented method for generating and providing shared bonus features and shared bonus games within electronic wagering games. The steps shown in FIG. 6 may be performed by any suitable computer-executable code and/or computing system, including the electronic gaming machines illustrated in FIGS. 1-3. In some examples, the steps shown in FIG. 6 may be performed by modules operating in an endpoint device such as an electronic gaming machine (EGM) (e.g., operating in a casino environment as described in connection with FIG. 1) or a personal user device (e.g., a smart phone, tablet, laptop, wearable device, and/or desktop), or by modules operating in a server (e.g., a backend computing device). In one example, each of the steps may represent an algorithm whose structure includes or is represented by multiple sub-steps, examples of which will be provided in greater detail below. In some examples, the steps may be executed by game processing backend system 314 as part of game processing architecture 300 as described in connection with FIG. 3.

The method 600 includes, at step 610, mapping, based on one or more random numbers generated by a random number generator (e.g., RNG engine 316), a plurality of game symbols (e.g., 430) from a set of reel strips (e.g., 426) to a plurality of symbol positions in a first game window. Then, at step 620, method 600 includes controlling a display device (e.g., 406) to display the plurality of game symbols, selected from the set of reel strips using the random number generator, in the plurality of symbol positions in the first game window. For example, as shown in FIG. 7, a game window 701 of an electronic wagering game may include an array 704 of value-bearing symbols arranged in three rows and five columns on fifteen separate reels (other grid shapes and sizes may also be used). Each reel may include a variety of different value-bearing symbols. In some cases, the value-bearing symbols may have a specified value by themselves or may only have value when matched with other (e.g., similar or same) symbols.

For instance, cash on reels (COR) symbols (e.g., 705) may have a specified instant cash value by themselves. This value may be multiplied if one or more other multiplier symbols are shown in the array. In other cases, multiple similar symbols need to be shown (e.g., three) during the same spin to create a match. At least in some cases, the COR values achieved in the first game window 704 are applied to a bonus grid 703. The bonus grid 703 may be populated with COR values achieved by different players, each playing their own instance of the electronic wagering game on their own electronic gaming machine. As different players achieve CORs in their individual games, those CORs may be placed into the bonus grid 703. As indicated by the different types of shading in FIG. 7, each COR value 705 may be assigned to or may correspond to an individual player. Each player that achieves a COR in the base game may be eligible to play in the group bonus game and may be eligible for a prize (e.g., a grand prize 702, a major prize, a minor prize, and/or a mini prize. At step 630 in method 600, the controller will trigger the group bonus game upon reaching a threshold number of CORs (or other specified symbol, if so implemented) among the group of players of the base game.

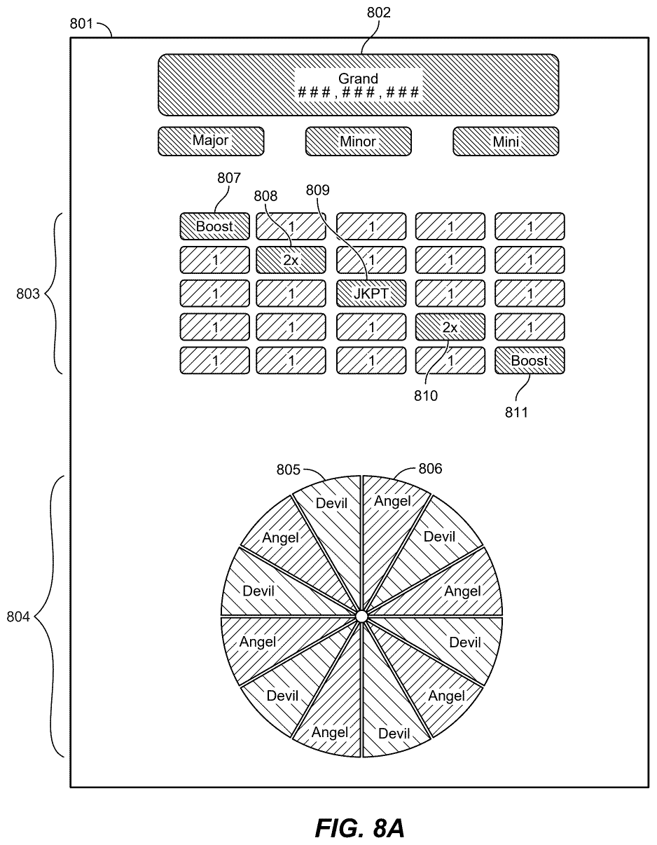

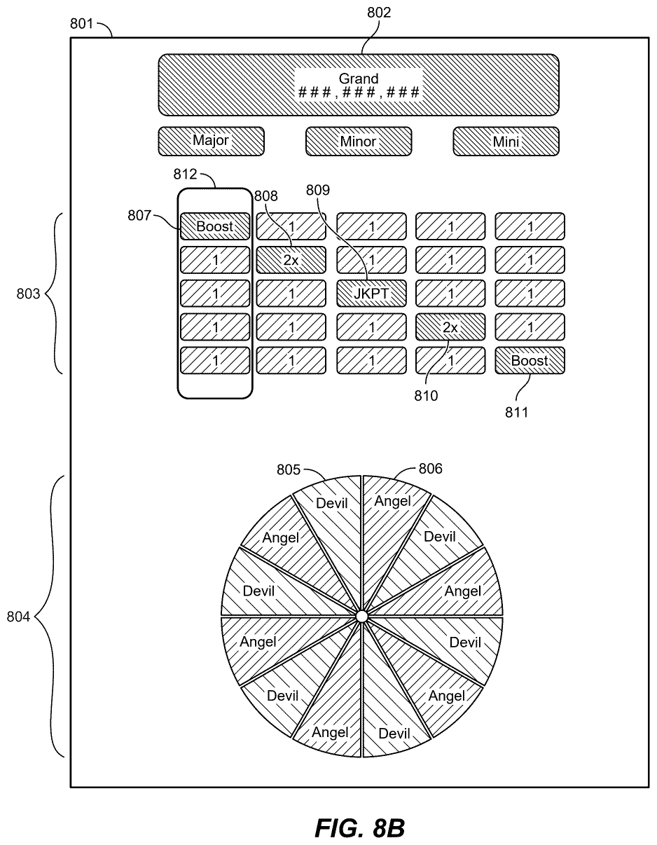

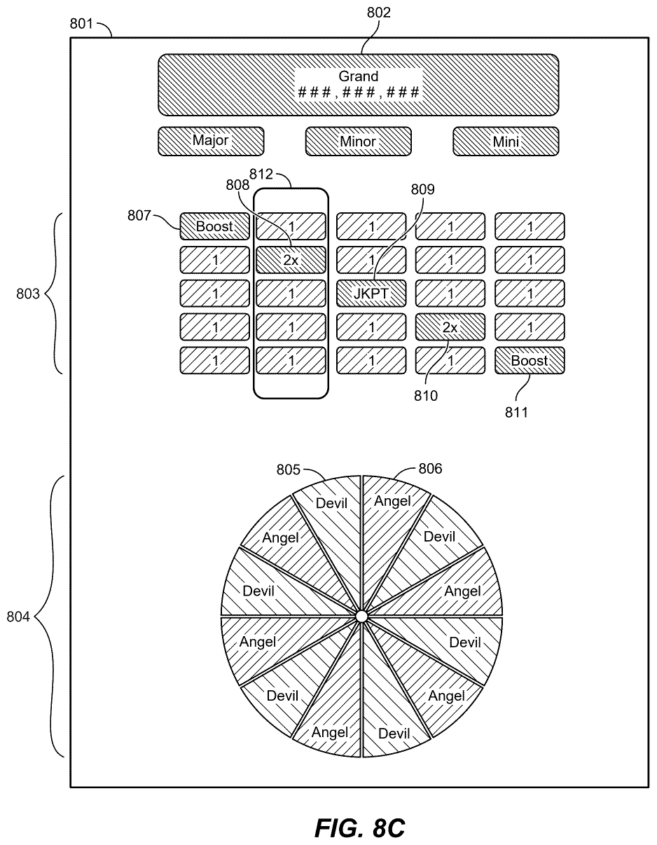

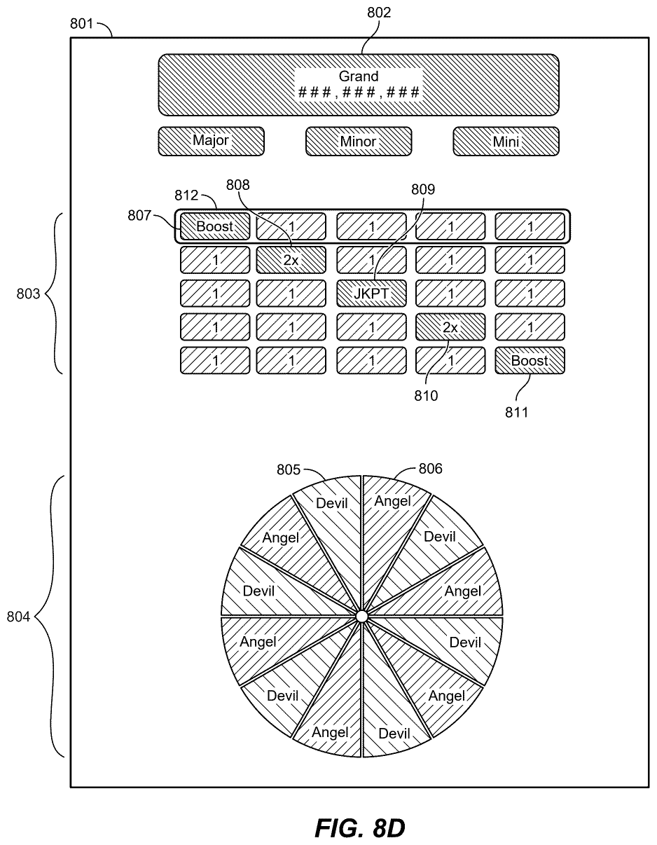

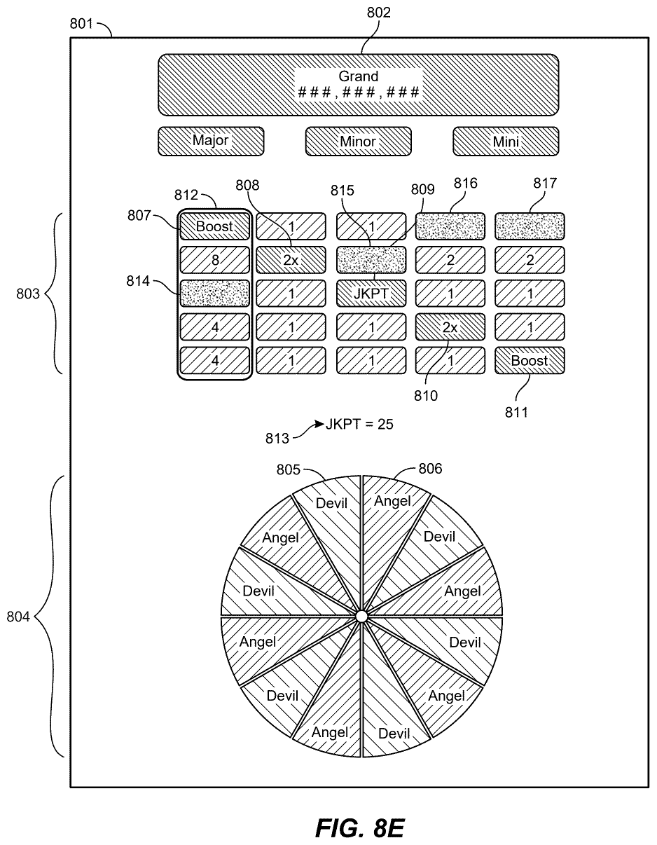

At step 640, the controller controls the display device (e.g., 406) to display a group bonus game window (e.g., 803 of FIG. 8A) that includes the specified symbols of the base game and/or the payout values associated with those symbols, as well as a plurality of boost features (e.g., 807-811) in symbol positions of the group bonus game window. Then, at step 650, the controller causes the display device to display a moving pointer (e.g., 807 of FIG. 8B) that lands in different positions in the group bonus game window. As will be explained further below, the moving pointer 807 incorporates a different plurality of symbol positions and corresponding values in each landing position. At step 660, the controller increments the values of those symbol positions that are incorporated by the moving pointer in its current position and, at step 670, upon determining that an end condition has been reached, accesses the memory to make an award of at least one or more values indicated by the incremented values in each symbol position that is incorporated by the moving pointer in its current position (as generally shown in FIG. 8E). This process will be explained in greater detail with reference to FIGS. 8A-8E.

At least in some embodiments, the electronic wagering game described herein may be provided to a plurality of players. These players may play in a common group, even when each of the players is playing the base game using a separate electronic gaming system. Each player may play the base game shown in FIG. 7. The base game may include a 3×5 grid of reels 704, where players are attempting to land COR values (e.g., 705) or other specified values or symbols. When a player in the group of players lands a COR value 705, that COR value is added to a shared grid of COR values (e.g., 703). This shared grid of COR values 703 may include COR values achieved by different players in the group. As the shared grid of COR values 703 fills with values, each player that has achieved a COR value may be added to the group of players that is eligible for a shared bonus game. At least in some cases, any player in the group that achieves a COR that is added to the shared grid of COR values 703 will be eligible to participate in the shared bonus game. Once the shared grid of COR values 703 has been filled, the filled state may act as a trigger to begin the shared bonus game among the eligible players.

As noted above, the shared bonus game may be presented on a gaming interface 801. The gaming interface 801 may include indications of different prizes 802 that are available, including grand prizes, major prizes, minor prizes, and mini prizes. The gaming interface 801 may also depict a shared bonus grid 803 that is shared among the players that are eligible for the shared bonus game. Each player involved in the shared bonus game may be presented with the same shared gaming interface 801 on their own separate electronic gaming system.

The gaming interface 801 may also include a spinning wheel (e.g., 804) or other interactive element that variably selects a value among at least two different symbol values. When the spinning wheel 804 is spun, the spinning wheel may come to a stop on a random location. That location may align with an “angel” value 806, a “devil” value 805, or some other symbol value. In this embodiment, if the spinning wheel 804 lands on an angel, at least some of the values in the bonus grid 803 may be incremented higher. If the spinning wheel 804 lands on a devil, the shared bonus game may end at that moment, or the shared bonus game may note the “devil” 805 and may allow for one, two, or some other number of additional “devil” spins before ending the shared bonus game.

At least in some embodiments, the shared bonus game may implement a moving pointer (e.g., 812) in FIG. 8B. The moving pointer 812 may incorporate two, three, four, five, or more symbol locations (e.g., 807). In the embodiment shown in FIG. 8B, the moving pointer 812 includes the five symbol locations in the leftmost column. As further shown in FIG. 8C, the moving pointer may move to the second column from the left, and then to the center column, to the second column from the right and to the rightmost column. The moving pointer may then move through each of the five different rows, including the topmost row shown in FIG. 8D, and to each subsequent row below until reaching the bottom row, and may also move through the two diagonals. The moving pointer 812 may move slowly between rows and columns and diagonals, or may move quickly (e.g., in synch or out of synch with the spinning wheel 804). In some cases, the moving pointer may incorporate diagonals or rows and columns that include less than all of the row or column (e.g., one, two, three, or four values instead of all five in that row or column). In some cases, the moving pointer may move in the reverse direction, such as moving up the rows from bottom to top, and/or columns from right to left. When the spinning wheel 804 stops spinning and lands on an “angel” value 806 (or other positive value), the values in the symbol locations that are incorporated in the moving pointer 812 will be incremented.

At least in some cases, the values in the symbol locations may be incremented by a common value across all of the symbol locations in the moving pointer 812. This common value may be determined independently or may be affected by the boost values (e.g., 807-811). The boost values may increase the value amounts at the symbol locations within the moving pointer 812 by a specified boost value (e.g., 807 or 811), by 2× (e.g., 808 or 810), or may result in a jackpot (e.g., 809).

Thus, within the shared bonus game, at least one of the players may initiate the bonus game by spinning the wheel 804. While the wheel 804 spins, the moving pointer 812 may move between different columns, rows, and/or diagonals, incorporating different symbol locations at each position. Once the spinning wheel 804 stops (or at some other designated time), the values currently in those symbol positions incorporated by the moving pointer 812 may be incremented by a set value or by a boosted value, if the moving pointer 812 incorporates a particular boost value (e.g., 807 or 808). This process may continue until the group of players has landed on a “devil” value 805 once, three times, or some other number of times. The group of players may then be returned to the base game, where they can again begin collecting COR values to participate in the next instance of the shared bonus game.

In some embodiments, the group bonus game may include at least two moving pointers (e.g., two moving pointers 812 on two different columns, or on two different rows, or on one column and one row, etc.). Each of these moving pointers may incorporate a different plurality of symbol positions and corresponding values in each landing position. In one example, one moving pointer may land on the leftmost column (as in FIG. 8B), while the other moving pointer may land on the second column from the left (as in FIG. 8C) or the top row (as in FIG. 8D). The values of each of the symbol positions that are incorporated by the two (or more) moving pointers may be incremented as described above.

Regardless of whether a single moving pointer is used or whether multiple moving pointers are used, the embodiments herein may increment the values of the symbol positions that were included in the moving pointer(s). FIG. 8E illustrates an embodiment where a single moving pointer 812 has landed in the leftmost column, incrementing each of those values by a specified amount based on which boosts or multipliers (e.g., 807 or 808) were included in the moving pointer 812, either for a single round or for multiple rounds, as the group of players continues to spin the spinning wheel 804. Some values may be incremented (e.g., 814 and 815), while other values may remain in their initial state (e.g., 816 and 817). The jackpot prize 813 may also be displayed within the game window 801.

In some cases, the group of players may include a fixed number (e.g., five players or 10 players, etc.), while in other cases, the group of players may include a variable number of players between a lower limit (e.g., three players) and an upper limit (e.g., 15 players). Each of those players may have an identifier or icon associated with them. In such cases, the base game may present player icons, images, colors, patterns, nicknames, or other features corresponding to the players in the group of players for each symbol position that has landed a cash on reels (COR) or other symbol. The COR game symbols may be presented differently for one user's CORs than a different user's CORs (e.g., using different colors or icons).

In cases where the base game is played on a 3×5 grid, and where the bonus grid is a 4×5 grid that displays the CORs accumulated by the group of players, once 20 COR values are placed in the 4×5 bonus grid that displays the accumulated CORs, the shared bonus game may be triggered. At least in some cases, those 20 values from the bonus grid are transferred to the group bonus game. Accordingly, in those embodiments, the 5×5 grid of the group bonus game (e.g., grid 803) may include COR values taken from the bonus grid in the base game (e.g., bonus grid 703 from FIG. 7), along with five boost values (e.g., 807-811). The COR values may be transferred to the grid in substantially any arrangement and, in some cases, may be shuffled prior to being placed in the 5×5 grid 803 of the group bonus game. These five boost values may be variable and may change for each instance of the group bonus game. For those players of the base game that did not contribute at least one COR to the bonus grid, the base game may present a message indicating that players that did not get into the group bonus game will be eligible to play for subsequent group bonus games.

At least in some cases where random numbers are generated and implemented within the electronic wagering game (e.g., using hardware random number generator 244 of FIG. 2A), the systems herein may carefully control or change the amount of randomness for each spin and/or for each reel in the spin to craft a specific outcome or range of outcomes. For example, in a 3×5 reel, such as reel 704 of FIG. 7, each of the reels may have multiple different value-bearing symbols. Each time the user spins the reels, the specific value-bearing symbols for each of the fifteen locations in the array may be chosen based on a random number. In some cases, the degree of randomness may be the same for each reel or for each location within the array. In other cases, the degree or amount of randomness may be different for each reel or for each location in the array.

In some cases, for example, the degree of randomness for a given spin increases or decreases for each reel, from left to right. Thus, in some examples, the degree of randomness may start at a specified level (X) for the first reel on the left. For the second reel, the degree of randomness may decrease to X−Y, where Y is a numerical value above zero. For the third reel, the degree of randomness may decrease further to X−Y−Z, where Z is a numerical value above zero, and so on through the fifth reel. In that case, each progressive reel would have a decreased level of randomness, thus making some outcomes more likely in each subsequent reel. In such embodiments, game designers may specify which outcomes are more likely to occur within the reduced parameters for randomness.

In other cases, the degree of randomness may start at a specified level (X) for the first reel on the left and may increase for each reel to the right. Thus, for the second reel, the degree of randomness may increase to X+Y, where Y is a numerical value above zero. For the third reel, the degree of randomness may increase further to X+Y+Z, where Z is a numerical value above zero, and so on through the fifth reel. Thus, in such cases, each progressive reel would have an increased level of randomness, thus making some outcomes less likely in each subsequent reel. Accordingly, in these embodiments, game designers may specify which outcomes are less likely to occur within the increased parameters for randomness. In still further cases, some reels may have increased randomness, and some reels may have decreased randomness within the same spin. Moreover, in some cases, the randomness of each reel is independently determined for that reel and is not based on the results of any previous reels. In such cases, each reel value is randomly determined, independent of other reels.

Moreover, at least in some cases, the degree of randomness may change dynamically based on the previously selected random values. Thus, if certain value-bearing symbols appear in the first or second reels (e.g., CORs or scatter symbols), other value-bearing symbols may be more or less likely to appear in the third, fourth, and fifth reels according to the dynamic changes in randomness. In this manner, the controller, either alone or in conjunction with the hardware RNG, may carefully control the level or degree of randomness for each spin, and for each reel in that spin. The degree of randomness may provide parameters for the randomly selected values, ensuring that the randomness is above a specified value (X) but below a specified value (Y). These values may be predefined or may be established and changed dynamically over time as a particular game is played.

In some cases, for example, randomness may be controlled or bounded to increase the likelihood of CORs appearing on one or more of the reels. Or, the randomness may be controlled or bounded to increase the likelihood of wilds or metamorphic trigger symbols or scatter symbols appearing on one or more of the reels. Still further, randomness may be controlled to increase the likelihood of multipliers or wild multipliers (that multiply any line win that passes through the wild) appearing on one or more of the reels in an array, or increase the likelihood of three-of-a-kind wins, four-of-a-kind wins, five-of-a-kind wins, etc. Thus, at least in some embodiments, the degree or amount of randomness may be controlled to apply bounds within which the hardware RNG operates. This control of the randomness used in the game may be managed and carried out by the game controller. The controlled randomness may then be used to select value-bearing symbols for each reel and, when sufficient scatter symbols are present or when a metamorphic has reached a peak level, a bonus gameplay mode may be provided in which previously locked arrays become available for play, leading to potentially higher winnings for the player and greater player satisfaction with the game.

At least in some embodiments, this controlled randomness may be implemented to randomly select symbols during a reel spin for any of the plurality of reel spins in an electronic wagering game (e.g., the base game and/or the group bonus game). In some cases, for example, the electronic wagering game may determine a gaming outcome (e.g., a set of matching symbols) by first selecting a reel set from multiple available reel sets (e.g., the far-left reel set in FIG. 4 that includes block reels 426(1), 426(2), and 426(3)). Each reel set may include unique reel strips that introduce a high probability of specific events occurring based on underlying weights associated with each reel set. Then, based on a random number generated by an RNG in a controlled randomness implementation, a first reel set may be selected from the plurality of reel sets, where each reel set includes multiple reel strips (e.g., 5 reel strips, 15 reel strips, etc.). Then, based on a random number for each reel, a reel spin outcome is selected. Each reel set of the various reel sets has a differing probability that a specific reel spin outcome will occur.

In addition to the electronic gaming system described above, a computer-implemented method may be provided that includes: conducting a base game among a group of players by mapping, based on random numbers generated by a random number generator, multiple game symbols from a set of reel strips to different symbol positions in a first game window, controlling the display device to display the game symbols, selected from the set of reel strips using the random number generator, in the symbol positions in the first game window, and triggering a group bonus game upon reaching a threshold number of at least one specified symbol among the group of players of the base game. The method further includes conducting the group bonus game among the group of players by controlling the display device to display a group bonus game window that includes the specified symbols of the base game and multiple boost features in symbol positions of the group bonus game window, causing the display device to display a moving pointer that lands in different positions in the group bonus game window, where the moving pointer incorporates a different plurality of symbol positions and corresponding values in each landing position, incrementing the values of those symbol positions that are incorporated by the moving pointer in its current position and, upon determining that an end condition has been reached, accessing the memory to make an award of values indicated by the incremented values in each symbol position that is incorporated by the moving pointer in its current position.

A non-transitory computer-readable medium may also be provided that includes one or more computer-executable instructions that, when executed by at least one hardware processor of a computing device, cause the hardware processor to: conduct a base game among a group of players by mapping, based on random numbers generated by a random number generator, multiple game symbols from a set of reel strips to different symbol positions in a first game window, controlling the display device to display the game symbols, selected from the set of reel strips using the random number generator, in the symbol positions in the first game window, and triggering a group bonus game upon reaching a threshold number of at least one specified symbol among the group of players of the base game. The hardware processor further conducts the group bonus game among the group of players by controlling the display device to display a group bonus game window that includes the specified symbols of the base game and multiple boost features in symbol positions of the group bonus game window, causing the display device to display a moving pointer that lands in different positions in the group bonus game window, where the moving pointer incorporates a different plurality of symbol positions and corresponding values in each landing position, incrementing the values of those symbol positions that are incorporated by the moving pointer in its current position and, upon determining that an end condition has been reached, accessing the memory to make an award of values indicated by the incremented values in each symbol position that is incorporated by the moving pointer in its current position.

In some examples, one or more of the devices and/or subsystems may be employed in any number of software, firmware, and/or hardware configurations. For example, one or more of the embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program may be loaded into one of the devices and/or subsystems. All or a portion of the computer program stored on the computer-readable medium is then stored in memory and/or a storage device. When executed by a physical processor, a computer program loaded into the memory causes the physical processor to perform and/or be a means for performing the functions of one or more of the embodiments described and/or illustrated herein. Additionally or alternatively, one or more of the embodiments described and/or illustrated herein are implemented in firmware and/or hardware. For example, one or more of the devices and/or subsystems herein may be configured as an ASIC adapted to implement one or more of the embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An electronic gaming system comprising:
a display device operable to display at least a portion of a plurality of reels, each reel having a plurality of symbol positions;
a controller comprising a processor and memory storing a symbol set including a plurality of symbols, and instructions, which, when executed, cause the processor to:
conduct a base game among a group of players by:
mapping, based on one or more random numbers generated by a random number generator, a plurality of game symbols from a set of reel strips to a plurality of symbol positions in a first game window;
controlling the display device to display the plurality of game symbols, selected from the set of reel strips using the random number generator, in the plurality of symbol positions in the first game window; and
triggering a group bonus game upon reaching a threshold number of at least one specified symbol among the group of players of the base game; and
conduct the group bonus game among the group of players by:
controlling the display device to display a group bonus game window that includes the specified symbols of the base game and a plurality of boost features in symbol positions of the group bonus game window;
causing the display device to display a moving pointer that lands in different positions in the group bonus game window, wherein the moving pointer incorporates a different plurality of symbol positions and corresponding values in each landing position;
incrementing the values of those symbol positions that are incorporated by the moving pointer in its current position; and
upon determining that an end condition has been reached, accessing the memory to make an award of at least one or more values indicated by the incremented values in each symbol position that is incorporated by the moving pointer in its current position.

2. The electronic gaming system of claim 1, wherein each player in the group of players plays the base game at a separate electronic gaming system.

3. The electronic gaming system of claim 2, wherein the group bonus game is shared across the various separate electronic gaming systems.

4. The electronic gaming system of claim 1, wherein the group bonus game further includes a spinning wheel with at least two symbol values.

5. The electronic gaming system of claim 4, wherein upon reaching a specified number of a first symbol value, the end condition is triggered.

6. The electronic gaming system of claim 4, wherein upon landing on a second symbol value in the spinning wheel, the values of those symbol positions currently included in the moving pointer are increased.

7. The electronic gaming system of claim 1, wherein the group bonus game includes at least two pointers that each incorporates a different plurality of symbol positions and corresponding values in each landing position.

8. The electronic gaming system of claim 7, wherein the values of each of the symbol positions that are incorporated by the at least two moving pointers are incremented.

9. The electronic gaming system of claim 1, wherein the group of players includes a variable number of players between a lower limit and an upper limit.

10. The electronic gaming system of claim 1, wherein the base game presents a player icon corresponding to one of the players in the group of players for each symbol position that has landed a cash on reels (COR).

11. The electronic gaming system of claim 10, wherein game symbols are presented differently for one user's CORs than a different user's CORs.

12. The electronic gaming system of claim 10, wherein the base game is played on a 3×5 grid, and wherein a 4×5 grid displays the CORs accumulated by the group of players.

13. The electronic gaming system of claim 12, wherein a plurality of COR values in the 4×5 grid displaying the accumulated CORs are transferred to the group bonus game.

14. The electronic gaming system of claim 13, wherein the group bonus game is played on a 5×5 grid that includes the plurality of COR values accumulated by the group of players and includes five boost values.

15. The electronic gaming system of claim 14, wherein the plurality of COR values are shuffled prior to being placed in the 5×5 grid of the group bonus game.

16. The electronic gaming system of claim 14, wherein the five boost values are variable for each group bonus game.

17. The electronic gaming system of claim 14, wherein conducting the base game further includes presenting a message indicating that players that did not get into the group bonus game will be eligible to play for a subsequent group bonus game.

18. The electronic gaming system of claim 17, wherein players that did not get into the group bonus game include players that did not land on a COR in the base game.

19. A computer-implemented method comprising:
conducting, by a controller comprising a processor and memory storing a symbol set including a plurality of symbols, a base game among a group of players by:
mapping, based on one or more random numbers generated by a random number generator, a plurality of game symbols from a set of reel strips to a plurality of symbol positions in a first game window;
controlling a display device to display the plurality of game symbols, selected from the set of reel strips using the random number generator, in the plurality of symbol positions in the first game window; and
triggering a group bonus game upon reaching a threshold number of at least one specified symbol among the group of players of the base game; and
conducting the group bonus game among the group of players by:
controlling the display device to display a group bonus game window that includes the specified symbols of the base game and a plurality of boost features in symbol positions of the group bonus game window;
causing the display device to display a moving pointer that lands in different positions in the group bonus game window, wherein the moving pointer incorporates a different plurality of symbol positions and corresponding values in each landing position;
incrementing the values of those symbol positions that are incorporated by the moving pointer in its current position; and
upon determining that an end condition has been reached, accessing the memory to make an award of at least one or more values indicated by the incremented values in each symbol position that is incorporated by the moving pointer in its current position. cm 20. A non-transitory computer-readable medium comprising one or more computer-executable instructions that, when executed by at least one hardware processor of a computing device, cause the hardware processor to:
conduct a base game among a group of players by:
mapping, based on one or more random numbers generated by a random number generator, a plurality of game symbols from a set of reel strips to a plurality of symbol positions in a first game window;
controlling a display device to display the plurality of game symbols, selected from the set of reel strips using the random number generator, in the plurality of symbol positions in the first game window; and
triggering a group bonus game upon reaching a threshold number of at least one specified symbol among the group of players of the base game; and
conduct the group bonus game among the group of players by:
controlling the display device to display a group bonus game window that includes the specified symbols of the base game and a plurality of boost features in symbol positions of the group bonus game window;
causing the display device to display a moving pointer that lands in different positions in the group bonus game window, wherein the moving pointer incorporates a different plurality of symbol positions and corresponding values in each landing position;
incrementing the values of those symbol positions that are incorporated by the moving pointer in its current position; and
upon determining that an end condition has been reached, accessing memory to make an award of at least one or more values indicated by the incremented values in each symbol position that is incorporated by the moving pointer in its current position.
